(19) United States
(12) Patent Application Publication
(10) Pub. No.: US 2010/0024741 A1
(43) Pub. Date: Feb. 4, 2010

(54) Buddy leash system

(76) Inventor: Robert Paul Schoppman, Brandon, FL (US)

Correspondence Address: ROBERT P. SCHOPPMAN, 120 JEFFREY DRIVE, BRANDON, FL, 33511, US

(21) Appl. No.: 12/221,237

(22) Filed: Aug. 1, 2008

(51) Int. Cl. A01K 27/00; A01K 29/00

(52) U.S. Cl. 119/795; 119/161

(57) ABSTRACT

A leash allowing a user to design and customize, meeting the needs of the animals and its user. Within the leash are areas that can be connected and disconnected from by means of quick connect/disconnect fasteners. Allowing options to be added for continuous use or can be removed when not in use leaving the leash at all times functional.

Such options in said system include interchangeable handles, for comfort and enhanced control. Various separate storage compartment options for use with transporting a collapsible bowl, water container, toys, animal waste bags and waste, as well as personal items of the user, additional leash extenders and multiple leash connections. User can also opt for color changes, reflective inserts, or other ornamentation designs, styles or graphics. All these options can be connected directly into the leash, with full or part time use, leaving the leash to remain one continual unit eliminating the need to own several different leashes, if any area or option in said system is damaged or lost by animal or user it can be replaced quickly and inexpensively without the need to replace the entire leash.

### CROSS-REFERENCE TO RELATED APPLICATIONS

This application claims benefit of U.S. Patent Provisional application Ser. No. 60/962,474 filed Jul. 30, 2007. All subject matter set forth in provisional application Ser. No. 60/962,474 is hereby incorporated be reference into the present application as if fully set forth herein.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to pet leashes, more specifically, to aid in the need to comfortably carry necessities safely and securely for use by either the animal or the user by providing a leash system of optional interchangeable parts or attachments while maintaining a continual leash.

2. Related Art

Many leash and storage systems have been developed with the use of clips, ties and fasteners with attachable storage bags or compartments. Such leash and storage systems are illustrated by Calhoun et al. (U.S. Pat. No. 6,192,835), Koseberg (U.S. Pat. No. 5,447,227), Sugalski (U.S. 2008/0006223), Manzella et al. (U.S. Pat. No. 6,460,488), Beaupre (U.S. Pat. No. 7,367,286).

Calhoun discloses a hands free leash system using quick connect fasteners to attach a leash to a belt around the user. Two ends of which have identical connecting members on the same piece, and when not attached to the user the animals collar still holds a section of the leash. The design of these pieces allow for no close quarter control of the animal.

Koseberg discloses a device that is attached to the user or attached to the leash handle by means of straps, and is designed to be a carry-all with various compartments requiring the carrying of many products for every use of the leash.

Sugalski discloses a leash handle with an integrated compartment that is attached to an existing leash handle for means of providing a single use storage compartment. This handle would need to be made ready each time before each use. Manzell discloses a animal leash with a comfort handle all connected with a cord-locking mechanisms, with threaded fasteners firmly fixing them together. No customization by the user is possible.

Beaupre discloses a implement for carrying waste as well as an all in one attachment Bag to an existing leash, creating a multi-compartment container, attached by elastic bands or held in hand.

Still there is a need for a leash system that allows for its user to be able to customize the leash with ease. A leash system that is quick, simple, easy to use and can allow the user to customize the leash with several different needs and uses in mind. Each attachment can be specific in need for the user or animal for walking, running or making visits to a veterinarian office or work site.

### SUMMARY OF THE INVENTION

The general objective of the present invention is to provide a new and unique leash system that allows the user freedom to customize and design a complete and continual leash for the specific needs of the animal and the user, with the arrangement of different attachment bags and holders, styles of handles, reflective and non reflective materials, choice of colors, patterns, designs or ornamentation. Made from materials like but not limited too, nylon webbing, elastic, cotton, plastic, foam, metal, wood.

The leash system comprises of a handle, a leash, attachment bag options and a collar connector all separated by and attached to each other by a quick-release connector comprising a buckle connector (female portion) and a pronged connector (male portion).

The handles are configured for convenient gripping with one hand and there are many different styles to choose from for comfort and control. These choices could be based on the size of the animal, comfort in handling the animal or animals, physical limitations of the user, or simply by color preference and style. Each handle has a quick release pronged connector (male end) attached to its end.

The leash (or center portion) has a quick release connector comprising a buckle connector (female portion) at one end and the pronged connector (male end) at the other end. Center leash portion to be designed with female quick release connector to connect to handle and/or other attachments, while the male end quick release connector is snapped into the collar connector that has a female quick release connector on it as well as a suitable connector for attaching to the animals D-ring connector on the collar.

Each leash portion can be of different lengths, colors, designs, patterns, ornamentation, reflective or non-reflective an made of many different material. The collar connection portion can as well be made up in the same fashion as the leash portion, but only with the female end quick release connector attached at one end and a suitable D-ring connector for attachment to the collar at the other end.

Each optional attachment bag for this leash system will open and close by best suitable means for manufacture using snaps, Velcro, sippers, strings or elastic, but are not meant to be limited by this means. They are to be permanently connected to a section of leash material that has a quick release connector comprising a buckle connector (female end) at one end and a pronged connector (male end) at the other. Placement of the attachment bag options are one-way only, ensuring each attachment is placed in the correct direction for safety to the animal, user and the products being carried.

This leash system allows the user to customize the leash quickly and easily through a large selection of attachments and quick release connectors. These attachments can be easily stored at home in a car or at the office, used full or part time and help carry much needed necessities for both animal and user.

### BRIEF DESCRIPTION OF THE DRAWINGS

FIG. 1 is an angle view of one customization of the invention in use on a dog during a pet-owner's walk.

FIG. 2 is an angle view of the invention in FIG. 1 without the optional attachments in FIG. 4, FIG. 24, FIG. 14 and FIG. 15.

FIG. 3 is an angle view of the invention in FIG. 1 and FIG. 2 with the optional attachments in FIG. 4, FIG. 24, FIG. 14 and FIG. 15.

FIGS. 4, 5, 6 and 7 are an angle view of the invention in FIG. 1 with the optional handle attachments disconnected from the invention.

FIGS. 8, 9, 10, 11, 12, 13, 14, 15 and 24 are an angle view of the invention in FIG. 1 with the optional bag attachments disconnected from the invention.

FIG. 16 is an angle view of a multi-dog attachment for said invention in FIG. 1.

FIGS. 17 and 18 are an angle view of a one-piece male/female connector attachment for said invention in FIG. 1.

FIG. 19 is an angle view of a leash extension attachment for said invention in FIG. 1.

FIG. 20 is an angle view of a printable leash extension attachment for said invention in FIG. 1.

FIG. 21 is an angle view of a reflective leash extension attachment for said invention in FIG. 1.

FIG. 22 is an angle view of the collar connector for said invention in FIG. 1.

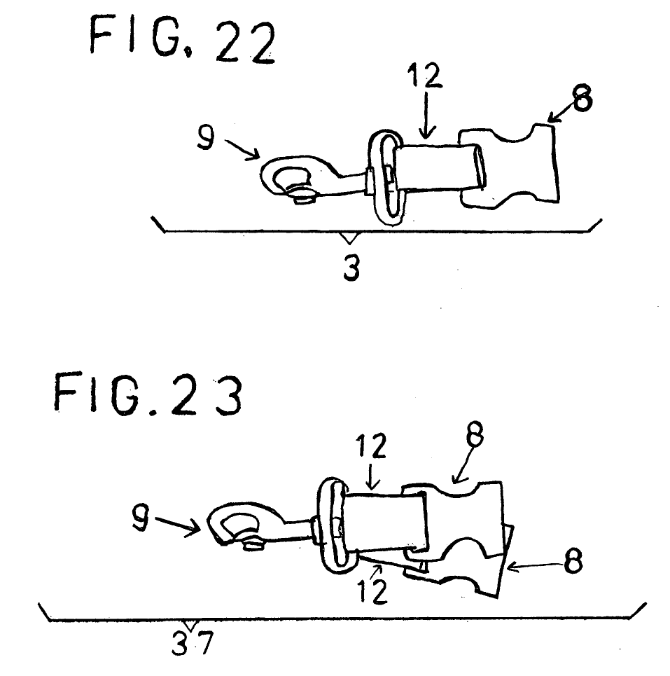

FIG. 23 is an angle view of a collar connector attachment for said invention in FIG. 1, with two female connectors.

### DETAILED DESCRIPTION OF THE INVENTION

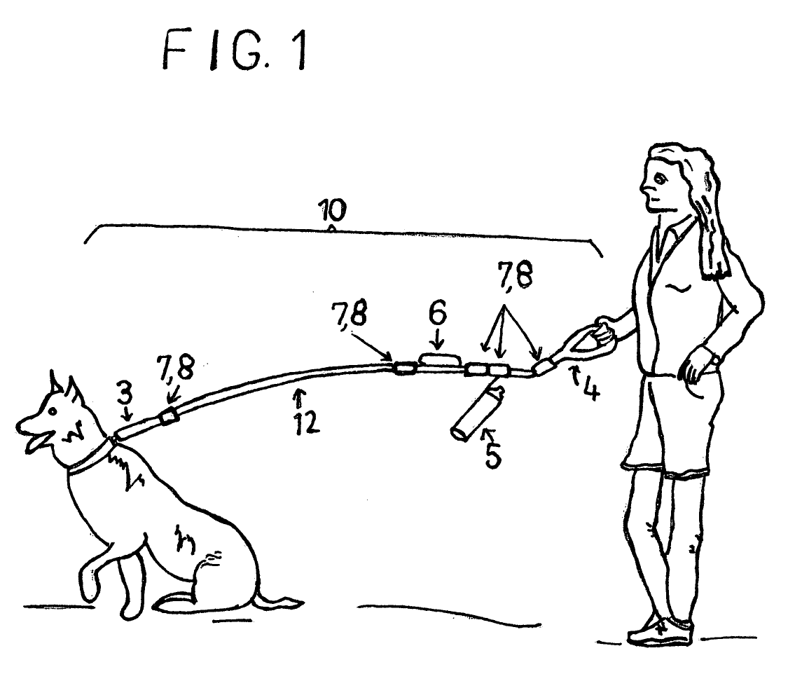

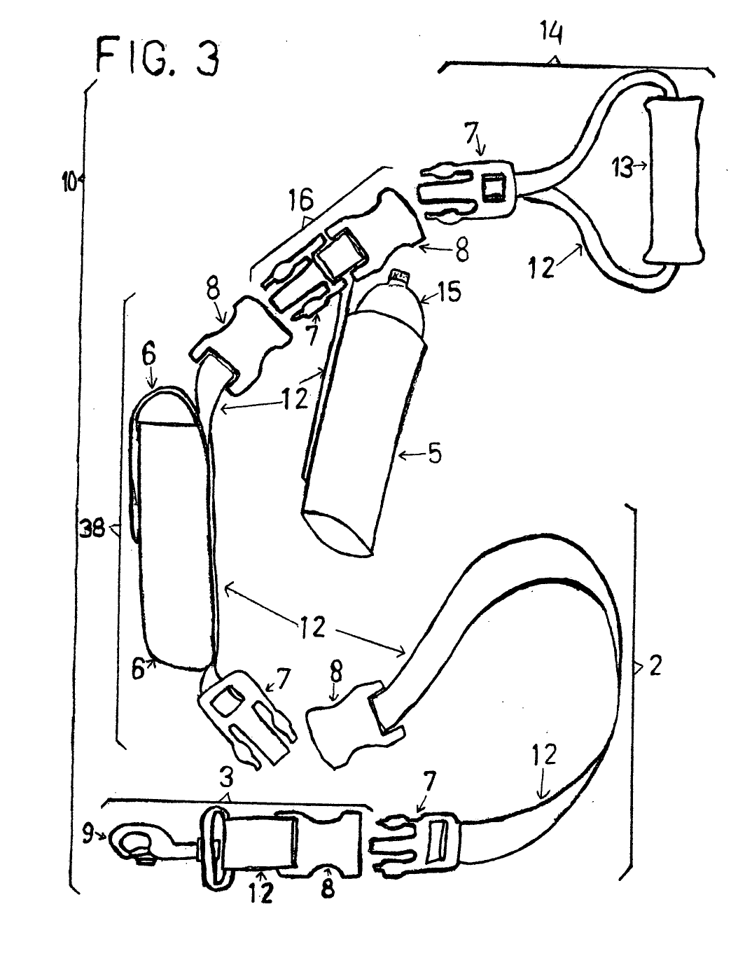

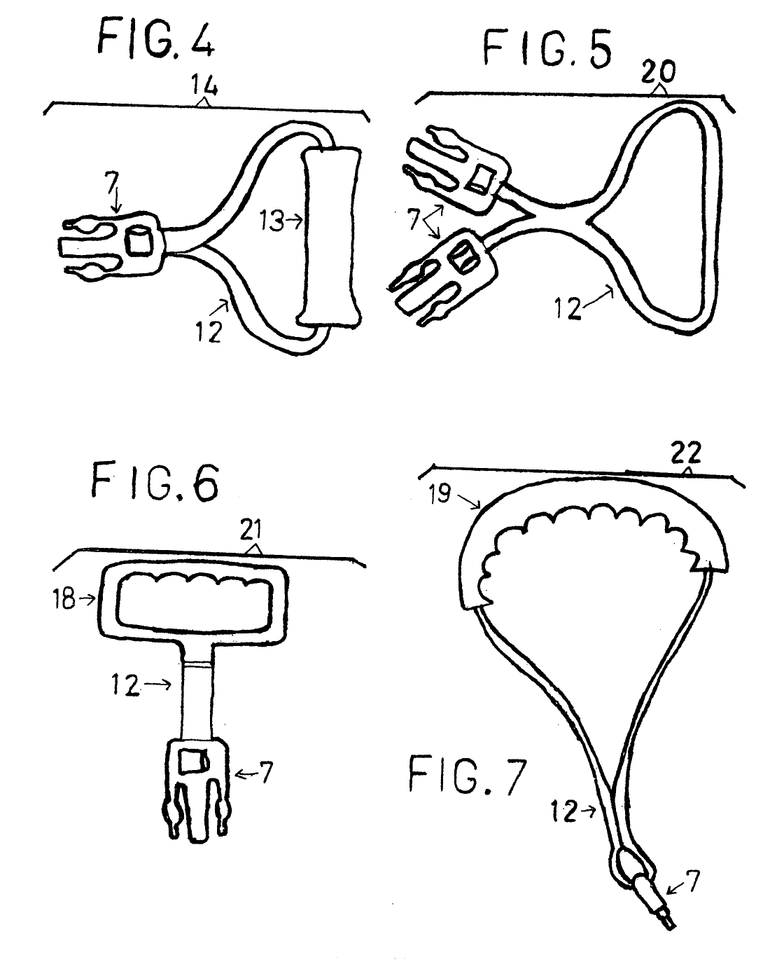

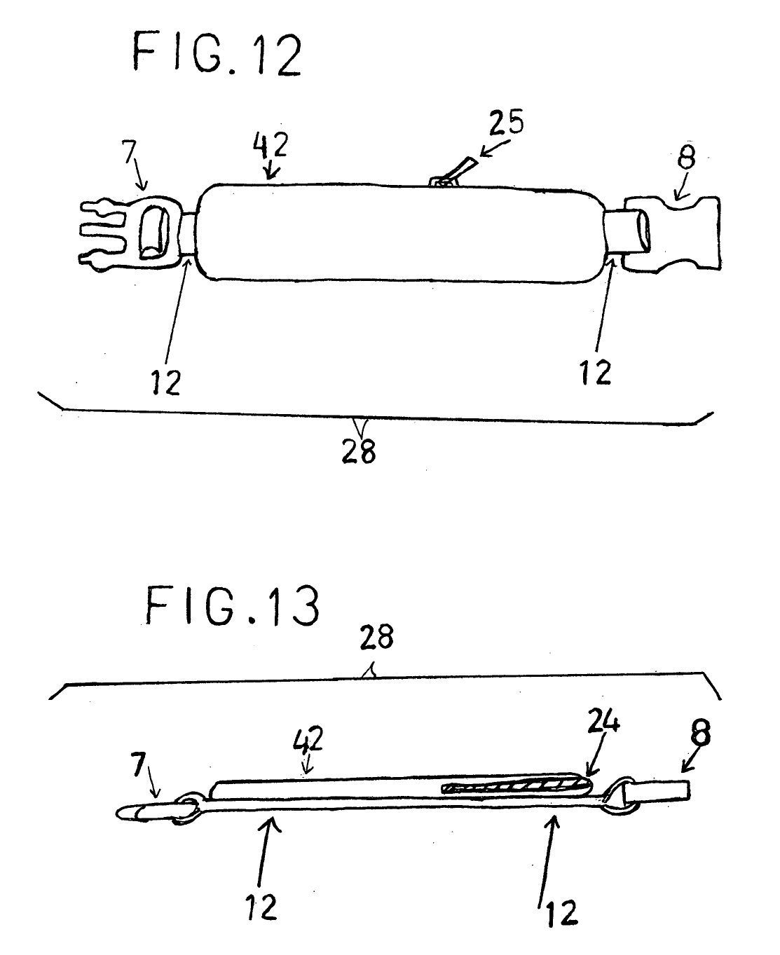

Referring to the drawing in FIG. 1 there is only one customization of the leash system 10, shown, but that is not the only configuration of the leash system FIG. 1 and FIG. 3. The leash system 10, is shown in use by the user and the animal FIG. 1 while taking a walk, the users specific needs or the animals necessities might require a different configuration of attachments FIGS. 4, 5, 6, 7, 8, 10, 12, 16, 17, 19, 20, 21 and 23 might be needed or preferred.

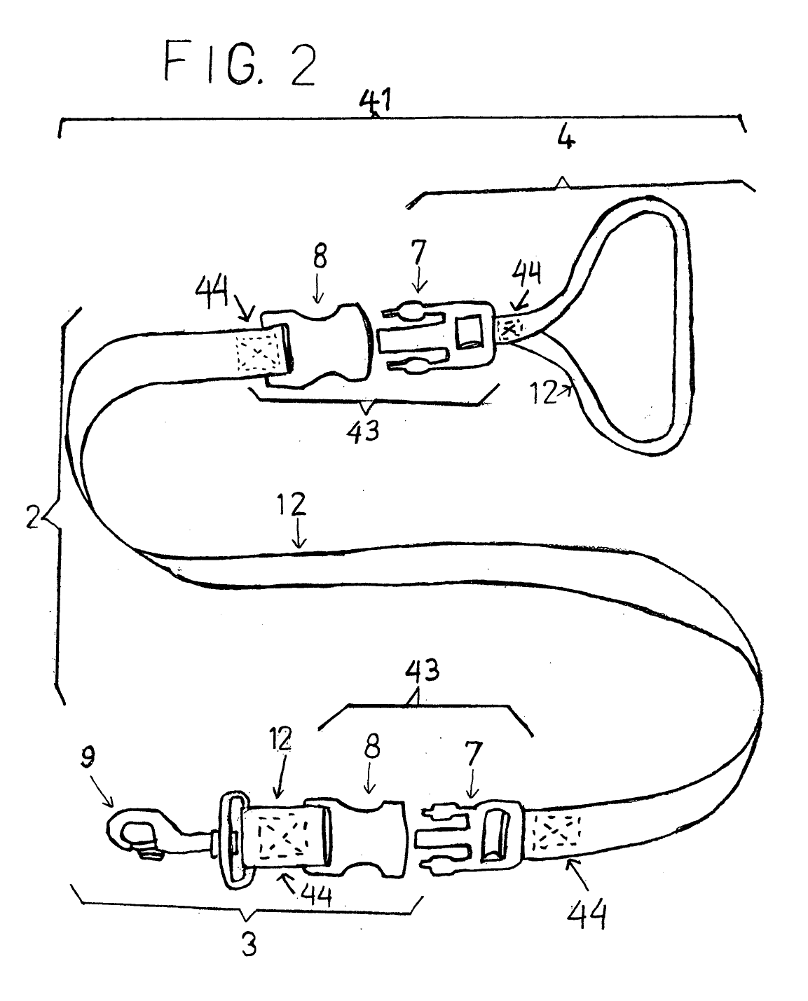

The leash system 41 includes a handle 4, a leash 2, and a collar connector 3. The handle 4, is a loop made of common nylon webbing 12, with a male pronged connector 7, at its end. The leash 2, is made of common nylon webbing and has a female 8, connector at its top end next to the handle 4, and a male connector 7, at its lower end next to the collar connector 3. The collar connector has a female 8, connector at its top end and a common snap bolt 9, at its other for connecting to an animal's collar, (not shown). Each component of the leash system 41, is separated by a common connector or fastener 43, with either or both the male 7, or female 8, end attached. These connectors or fasteners 43, are easy to use by snapping together, and normally require only one hand to operate, attachments FIGS. 4 thru 21, 23 and 24 and or connectors 43, are one-way only, ensuring continual proper connection and direction for the safety of the animal, its user and the necessities being carried. Each end of the fasteners 43 is connected to the nylon webbing 12 by means of looping thru the fasteners 43 ends and sewing an X box stitch 44, shown in FIG. 2, glue and heat molding can also be used.

Nylon webbing 12 is the preferred material, but these sections 12 can be of various fabrics and or materials.

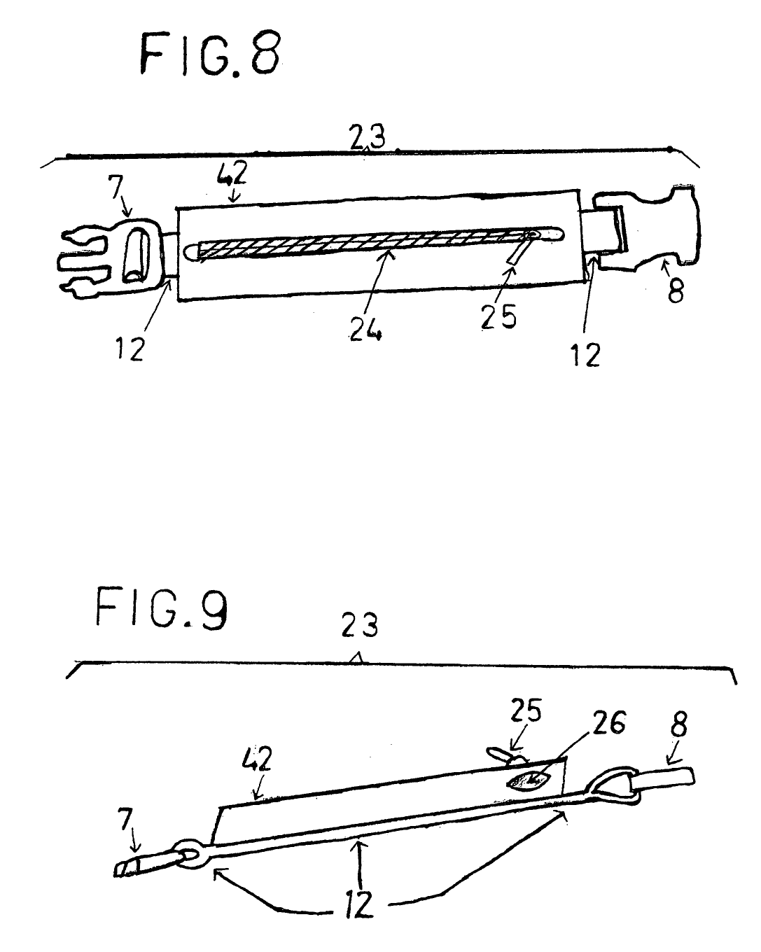

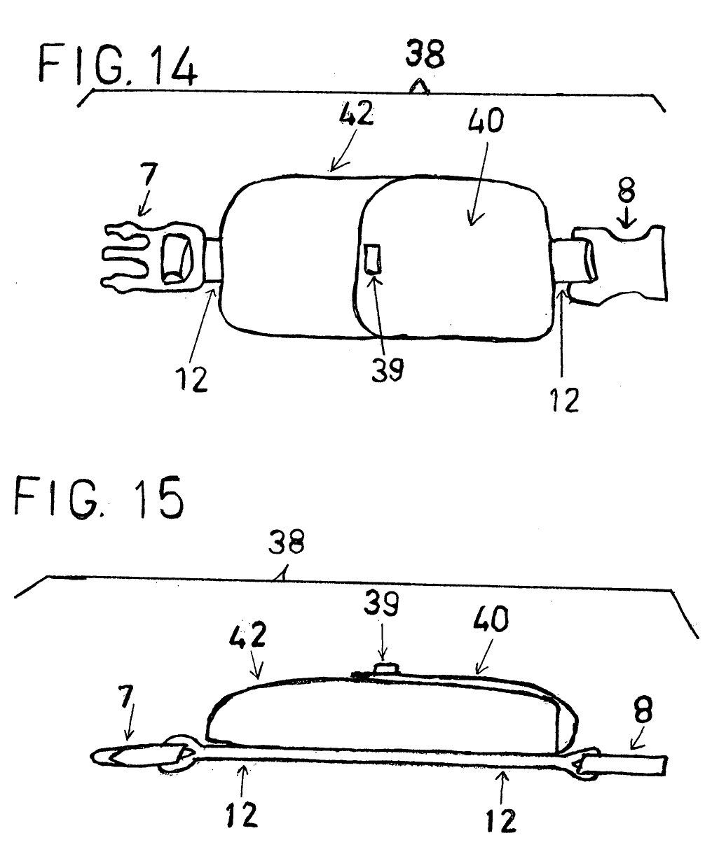

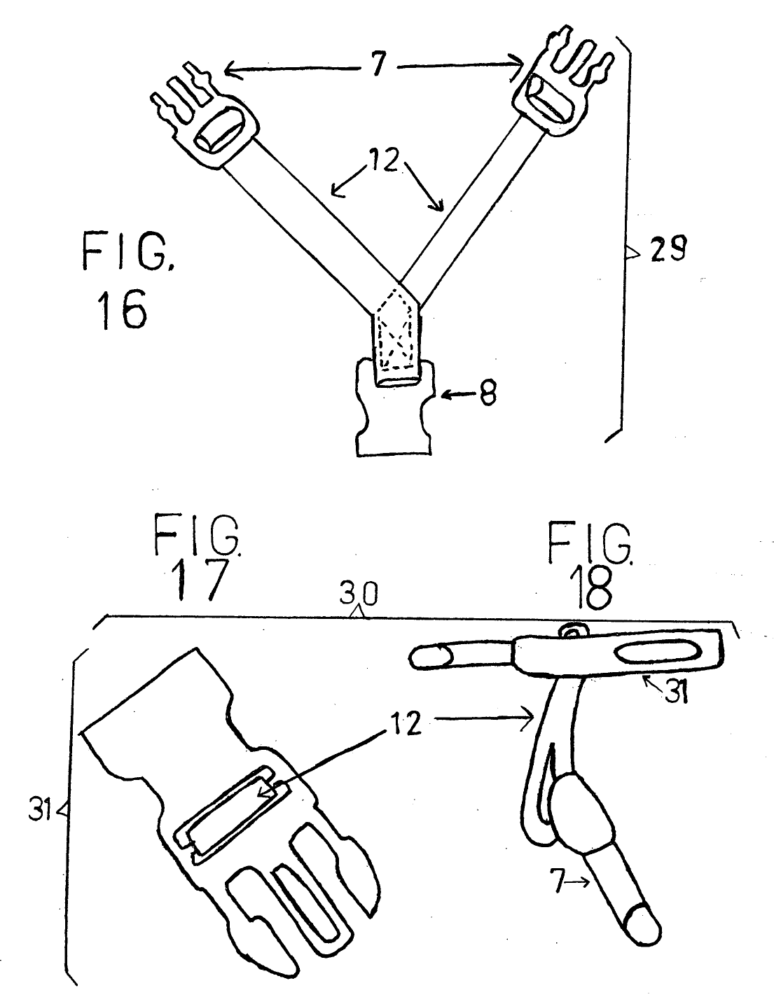

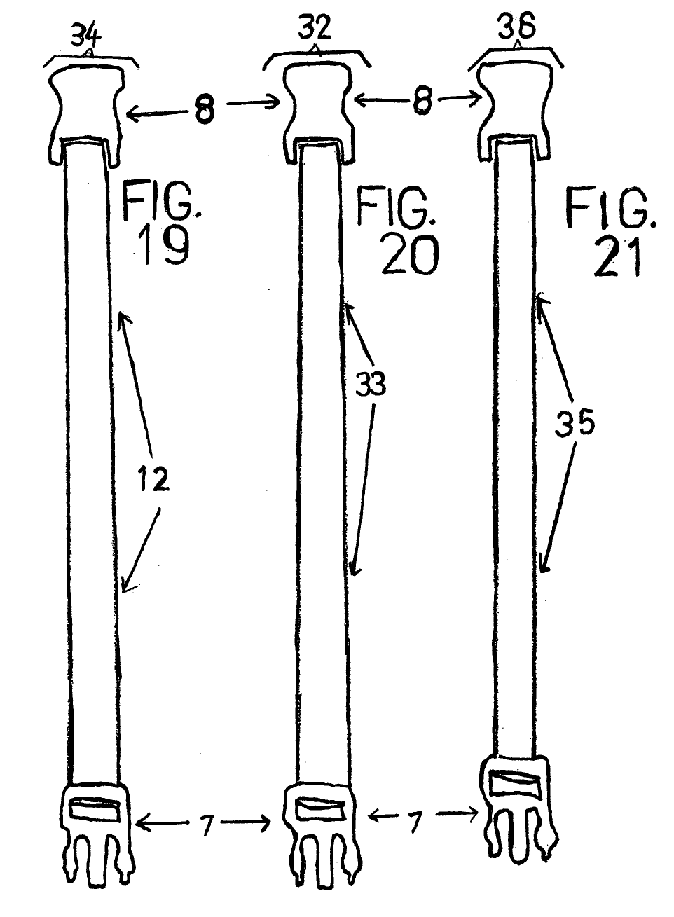

At its simple state FIG. 2 the said invention allows its user to customize if needed, handle 4, FIG. 2 can be exchanged with handle 14, FIG. 4's handle, or handle 4, FIG. 2 can be directly connected to the collar connector 3, FIG. 2, for close quarter control of the animal. Each handle of said invention 10, aids in the customization of the leash system 10. FIG. 4 allows a handle with a foam grip 13, for added comfort. FIG. 5 allows for a handle 20 to control two animals close to the handle 20 and the user. FIG. 6 allows the user a stronger, firmer handle 21, with an enlarged opening 18 with better grip control. FIG. 7 allows the user a wider handle opening 19, with ease of holding. All of the handles FIGS. 4, 5, 6, and 7 are interchangeable with the leash systems FIG. 2 handle 4. Such handle options FIGS. 4 thru 7 allow a user to customize their own leash for reasons of control, comfort, physical limitations, or style. Same is true for said invention 10 with the continued customization of the leash system 10 with the many bag attachments FIGS. 10 thru 15 and FIG. 24. FIG. 10 allows its user to carry his or her wallet and or keys safely in a zippered 25 bag firmly attached to the leash system 10 by means of fasteners 7,8, and connected continually to the leash 12. All the bag attachments are sewn directly to the leash 12 material with several X box stitches 44. Other bag attachments for said leash system 10 can carry dog waste FIG. 8 and easily dispense waste bags from a pull out side opening in the attachment bag 26, FIG. 9. If the user wishes to carry leash extensions FIG. 19 or a certain design or reflective extensions FIGS. 20 and 21, the user could carry them in the optional leash extension bag FIG. 12. If the user needed to carry a collapsible water bowl, treats, toy or any other practical necessity, the user would only need to attach the optional, larger attachment bag FIG. 14, 15, to the leash system 10, and since water is a very important part of a healthy walk for both animal and user the optional liquid container attachment FIG. 24 with liquid container 15, can be attached.

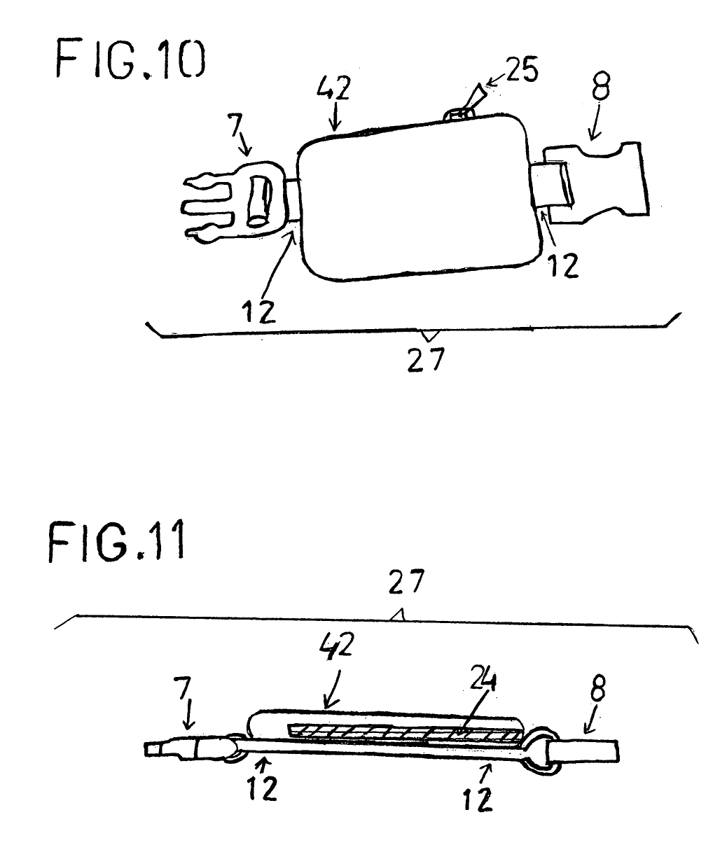

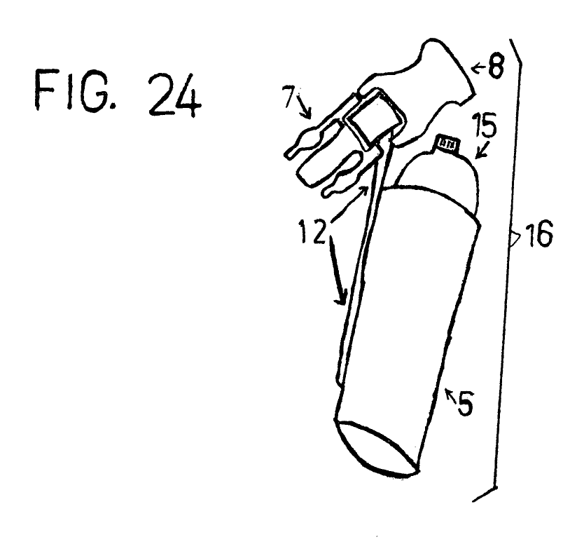

There are several ways to walk two or more animals with this leash system 10, as mentioned before, the optional duel-leash handle FIG. 5 offers a close to user option, while the optional multi-dog attachment FIG. 16 allows for the animals to be attached at any number of locations along the leash system 10, coupling together two or more of the multi-dog attachments FIG. 16 can allow for more then two dogs being walked at once. The multi-fastener collar connection FIG. 23, would also allow for multi-dog walking by one user. The leash systems 10, duel leash handle FIG. 5 and the multi-female fastener collar connector FIG. 23, work well together for users that have to often close quarter their animal, but don't want to ever disconnect the animal from the leash system 10, at any time. This option for safety is especially needed with young untrained animals or hard to control animals or animals that need to be regularly taken into the public or on the many different types of public transportation.

The leash system 10 is simple and easy to use, attractive and comfortable, while totally customizable, offering many custom configurations, for use, as mentioned, but is not limited to only the configurations mentioned. The leash system 10 offers the user the ability to an alternate means of carrying necessities for most uses while walking an animal, rather then the large heavy bags or heavy belts, that the user must wear on their person, or the large heavy cumbersome all in one multi-use bags that have to be carried around, tied or hung over the a leash handle. The leash system 10 is lightweight and can be very compact, while options and attachments can FIGS. 4 thru 24 easily be stored when not in use, or just not required for use. The leash system 10 and its attachments FIGS. 4 thru 24, are primarily for use with animals and their users, but it is not the intention to limit it only too the above described. Some of the leash systems 10 art will work well with other uses like a child's harness, camping supplies and/or products in the sporting goods industry.

What is claimed is:

1. A leash system that is customizable by options, attachments and design, filling the needs of animal and the user, while remaining a continual leash, the leash system comprising:
(a) a handle section, a leash section and a collar connector section. These three sections comprising a top part, middle part and a bottom part collectively known as the leash system.
(b) a leash system that is separable in part by quick connect/disconnect fasteners and rejoined by quick connect/disconnect fasteners that are attached to nylon webbing material, the width of which is equal to the material receiving end of the fasteners.
(c) a leash system that can accept addition or replace existing options or attachments by means of quick connect/disconnect fasteners, attached and matched to existing said leash systems fasteners and its design, while remaining a continual leash.

2. A leash system as defined in claim 1 comprising of optional handles that can replace the existing handle or top part, made of like nylon webbing material, but offering distinct hand gripping solutions for function and design.
(a) an optional handle with a pre molded foam member attached to the nylon webbing by means of a pre-cast center hole down the center for the webbing to pass through it creating a soft feeling, gripping surface for comfort and aid in control and assistants for some physically limited users.
(b) an optional handle with two female connectors attached to the nylon webbing and safely allowing for two animals to be connected to with matching materials of said leash system.
(c) an optional handle with a pre formed die-cast plastic molded handle in cased around the handle section of the nylon webbing, creating a large pre-formed handle engineered for heavier and strong animals.
(d) an optional handle section made of colorful plastic material and in two parts, a left and right that snaps together over the nylon webbing to form a wider opening on the handle so that the nylon will not be able to close tightly on the user hand when the animal pulls.

3. A leash system as defined in claim 1 comprising of optional leash sections or the middle part, that can replace or connect into optional attachment bags, through the placement of a female and male quick connect/disconnect type fastener. All attached to and made of nylon webbing material for the leash and a flexible, resilient, water resistant material for all the attachment bags.
(a) an optional animal waste bag and waste attachment bag, elongated and attached to the nylon webbing with stitching, the attachment bag opens and closes with a full length sipper located on the top of the bag, with a small opening on either side for the pull out removal of the waste bags for pick up.
(b) an optional wallet and key attachment bag, squared in design to fit most wallets and stitched to the nylon webbing, with a zipper three fourths around the sides of the bag for safety in holding personal items. A small interior pocket with Velcro can store keys.
(c) an optional extra leash extension attachment bag, rectangular in design and stitched to the nylon webbing with a zipper three fourths around the sides of the bag. Allowing for extension leashes to be stored inside.
(d) an optional extra large attachment bag, same size as the wallet key attachment bag, but with higher side walls, stitched to the nylon webbing, the opening is on the top end of the bag with a flap type cover, securing it with a piece of Velcro stitched to the flap, and the body of the bag.
(e) an optional liquid container attachment bag, cylinder in shape and of the size of an average hand held water bottle, this bag has a stitched strip of nylon webbing down the side of the bag with both fasteners attached at one end, and is recommended to be attached as close to the handle as possible, to ease in weight distribution. Designed for water this bag can hold a liquid container for animal or user.
(f) an optional extension leash, made of nylon webbing and designed to be longer then the middle part leash section, this nylon webbing attachment, can be any color or design, with or with reflective material, contain logo or advertisement slogans, or other ornamentation.
(g) an optional multi-dog connector, made of nylon webbing and with one female end connector and two male end connectors, connected in to the leash allows for two animals to be walk when same leash system materials are used.

4. A leash system as defined in claim 1, comprising of a collar connector section of bottom part, that can replace the existing collar connecting section with a collar connector section made of same materials.
(a) an optional duel female connector end with snap bolt attached, allowing for two animals to be attached at bottom end of leash system.
